(19) United States
(12) Patent Application Publication
(10) Pub. No.: US 2023/0111314 A1
(43) Pub. Date: Apr. 13, 2023

(54) A GNSS signal acquisition method based on FPGA step-by-step code phase refinement

(71) Applicant: SHAN DONG UNIVERSITY, Jinan (CN)

(72) Inventors: Juanjuan SUN, Jinan (CN); Mengqi CHEN, Jinan (CN); Xuezheng HUANG, Jinan (CN); Yong WANG, Jinan (CN); Xing WANG, Jinan (CN); Zihan WU, Jinan (CN)

(21) Appl. No.: 16/958,019

(22) PCT Filed: Nov. 13, 2019
(86) PCT No.: PCT/CN2019/117985

§ 371 Date: Jun. 25, 2020

(30) Foreign Application Priority Data
Jun. 18, 2019 (CN) 201910527105.5

(51) Int. Cl. G01S 19/30; G01S 19/29

(52) U.S. Cl. CPC G01S 19/30; G01S 19/29

(57) ABSTRACT

A GNSS signal acquisition method based on FPGA step-by-step code phase refinement comprises steps as follows: (1) Coarse acquisition: correlate all received data with the locally generated carrier and the complete pseudo-random code to find the maximum correlation value; obtain the carrier and the rough code phase for fine acquisition if the maximum correlation value conforms to the acquisition threshold; otherwise, repeat Step (1). (2) Fine acquisition: feedback the carrier and the coarse acquisition code phase value from Step (1) to the controller so that the controller can intercept partial of the received signal for mixing with the local carrier from Step (1); then, correlate the result with partial pseudo-random code after eliminating the influence of the carrier to obtain a code phase with higher accuracy.

### TECHNICAL FIELD

The invention is related to a GNSS signal acquisition method based on FPGA step-by-step code phase refinement, and belongs to the technical field of satellite positioning and navigation.

### BACKGROUND ART

The satellite positioning technology is widely used in daily production, life and military fields, and can provide all-weather real-time positioning, navigation and timing services. A satellite positioning system generally comprises three parts, space segment, ground segment and user reception equipment segment respectively. Among them, the user reception equipment is used to receive satellite signals, and to realize satellite positioning finally through acquisition, tracking, location computation and other processing of the signals. The purpose of acquisition and processing in the reception equipment is to identify all visible satellites, obtain the rough carrier frequency and code phase of the satellite signals, and provide initial values for the tracking loop, thus laying a basis for the realization of satellite positioning.

So far, user receivers realized by software have been very mature and can develop complex algorithms quickly with good flexibility. However, they are limited by the slow signal processing speed.

FPGA has abundant hardware resources and features parallel signal processing, fast computation speed, high flexibility and a short development cycle. Therefore, it is of great significance to study the implementation of receivers on FPGA.

In FPGA implementation of traditional acquisition algorithms, the amount of data to be processed is affected by the sampling rate of the satellite IF signals. A greater sampling rate is associated with a larger amount of data in unit time, which may result in too large a computation load and the hardware resources required exceeding the standard. Therefore, it is often necessary to carry out down-sampling treatment at the beginning of data processing. Down-sampling, however, will affect the correlation properties between the data and local codes, resulting in some errors in the output carrier frequency and code phase value, though it can reduce the computation load and the required resources. When too large errors occur, the subsequent tracking loop will become unable to be locked, making the acquisition results unusable.

Most of the existing methods used to reduce code phase errors are to reduce the search step size in the time domain after completion of frequency domain search for research, which spends a long time on acquisition and consumes a lot of resources.

### DESCRIPTION OF THE INVENTION

To address the shortcomings of the existing technologies, the invention provides a GNSS signal acquisition method based on FPGA step-by-step code phase refinement.

The invention divides the acquisition process into two steps: coarse acquisition and fine acquisition. The coarse acquisition is used for parallel code phase search for down-sampling. After obtaining the code phase and carrier frequency of the coarse acquisition, the data of some points are obtained from the chip in front of the coarse acquisition code phase. After eliminating the influence of the carrier, the data is correlated with a part of local pseudo-random code to find the exact code phase corresponding to the maximum correlation value. This kind of step-by-step code phase refinement acquisition method can not only reduce the error of code phase, but also reuse the original acquisition module, thus reducing acquisition time and saving hardware resources.

### Explanation of Terms

1. Frequency mixing: It refers to the process of mixing two signals of different frequencies to get a signal of the third frequency by using nonlinear operations. In the present invention, a multiplier is used to multiply the input signals modulated with cosine signals and the locally generated sine and cosine signals to achieve the purpose of frequency mixing.

2. Orthogonal mixing: It refers to the process of multiplying the input signals and the orthogonal sine and cosine signals for mixing.

### The Technical Solution of the Invention Is As Follows

A GNSS signal acquisition method based on FPGA step-by-step code phase refinement, which runs in an acquisition system comprising a local oscillator, a down-sampling module, a Fourier transform module, a local pseudo-random code generator, an inverse Fourier transform module, and a controller. The local oscillator is used to generate orthogonal local sine and cosine carrier signals; the down-sampling module is used to down sample long signals with high sampling rate into short signals averagely; the Fourier transform module and inverse Fourier transform module are used to realize the corresponding mathematical operations; the local pseudo-random code generator is used to generate local pseudo-random codes for different satellites; and the controller is used to control the data acquisition, the down-sampling rate, and the acquisition of a part of the local pseudo-random code according to the results of the last acquisition. After the input signal is multiplied by the orthogonal two carrier signals generated by the local oscillator for mixing, the down-sampling module conducts down sampling for the two output signals. After down sampling, the two output signals will be used as real part and imaginary part input signals for the Fourier transform module respectively to obtain intermediate signal I through Fourier transform. At the same time, the local pseudo-random code generator generates a local pseudo-random code which will be input into the Fourier transform module after down sampling in the down-sampling module. Then, intermediate signal II is obtained after taking the conjugate of the signals output by the Fourier transform module. The intermediate signal I is then input into the inverse Fourier transform module for Fourier inverse transform after being multiplied by the intermediate signal II. After modulo operation and square operations, a correlation value will be output for acquisition judgment. The judgment result is then input into the controller for control of the next acquisition. The specific steps are as follows:
A. coarse acquisition:
1) Take a N-point GNSS signal r(n) (sampling frequency: fₛ), and multiply it by the sine and cosine carrier signals sin(2πf_{carry}) and cos (2πf_{carry}generated by the local oscillator for frequency mixing respectively to get two data, respectively I and Q. The said N-point GNSS signal is a signal that contains a complete pseudo-random code period, while the said complete pseudo-random code period shall contain n chips. fₛ ≥ 2f_{I}, where: f₁ is the center frequency of the digital signal being processed; f_{carry} = f₁ - |f_{Doppler}| | + Δ • i, where f_{Doppler} is the frequency offset caused by the Doppler effect, and is generally±10 KHz; Δ is the step size for carrier frequency search, which is user-defined and generally 500 Hz; and
$$i = 0 , 1 , 2... , 2 \times \frac{{f}_{D o p p l e r}}{Δ} ;$$
2) Conduct M-point uniform down-sampling for the two data I and Q obtained from Step (1) , and use the results as real part and imaginary part respectively for M-point fast Fourier transform (FFT); M is an integer power of 2 and M < N;
3) Conduct M -point uniform down-sampling for the locally generated pseudo-random code (sampling frequency of fₛ), and take the conjugate of the result after the Fourier transform operation;
4) Multiply the fast Fourier transform (FFT) result from Step (2) by the conjugate result of the pseudo-random code from Step (3) to get Y(k), and then conduct M-point inverse fast Fourier transform (IFFT);
5) Perform modulus and square operations on the result from Step (4) to get the sequence of correlation values of the GNSS signal with the local carrier and the local pseudo-random code. Then find the maximum value Max and the secondary maximum Second_{Max} in the correlation value sequence. If Max ≥ 3 × Second_Max, the coarse acquisition can be judged as completed. Then, the frequency of the local carrier is just the carrier value of the coarse acquisition, and the position of the maximum value Max in the correlation value sequence is just the coarse acquisition code phase value. If so, continue with Step (6). Otherwise, return to Step (1); increase the i in Step (1) by 1, change the frequency of the orthogonal carrier signals generated by the local oscillator for the next frequency search.
B. Fine acquisition:
   6) Feedback the carrier value and the coarse acquisition code phase value obtained from the coarse acquisition in Step (5) to the controller; the controller controls the input of data by reading a N′-point (M ≤ N′ < N) part of the GNSS signal data from the chip in front of the coarse acquisition code phase value obtained from the coarse acquisition and multiply it by the carrier value obtained from the coarse acquisition for orthogonal mixing to eliminate the influence of the carrier and get the two data I1 and Q1;
   7) Conduct M-point uniform down-sampling for the two data I1 and Q1 obtained from Step (6) under the control of the controller, and use the results as real part and imaginary part respectively for M-point fast Fourier transform (FFT);
   8) After controlling the local pseudo-random code generator to sample at the frequency of fₛ, the controller takes a N′-point part of the pseudo-random code (the same long as that in Step (6)) for M-point uniform down-sampling and fast Fourier transform (FFT) operation, and then takes the conjugate;
   9) Multiply the data after fast Fourier transform (FFT) from Step (7) by the conjugated data after fast Fourier transform (FFT) from Step (8) for inverse fast Fourier transform (IFFT) operation;
   10) Perform modulus and square operations on the result from Step (9) to get the correlation values of the GNSS signal with the local carrier and the local pseudo-random code. Then find the position corresponding to the maximum correlation value. If the position differs from that of the last acquisition by less than one chip, the fine acquisition can be judged as effective. Then, the position corresponding to the maximum correlation value is just the code phase obtained by the fine acquisition. The fine acquisition ends when N′ = M is met. Otherwise, return to Step (6), and take the chip in front of the code phase of the fine acquisition as starting position of the next fine acquisition to continue with fine acquisition by reducing the data length.

According to a preferred embodiment of the invention, the said M-point uniform down-sampling comprises the steps as follows:
The data of FFT operation must be an integer power of 2. When the amount of data of FFT operation is too large, the time required to complete the computation and the hardware resources consumed will become too large to bear, so the data generally need to be down-sampled.

$$\frac{N}{M} ,$$
where: m refers to the number of original data points contained in each down-sampled data point, also known as down-sampling multiple;
When m is an integer, add up every m data as a data point;
When m is not an integer, the following relational expressions are satisfied, as shown in equation (I):
$$\left\{\begin{matrix}a < m < b \\ a x + b y = N \\ x + y = M\end{matrix}\right)$$
Where: α and b are integers that are closest to the m respectively; x is the number of summation times for every α consecutive points; and y is the number of summation times for every b consecutive points. α-point summation and b-point summation are to be distributed evenly across the data to complete uniform down-sampling. In fine acquisition, the data length may be selected as an integer power of 2 to facilitate down-sampling while avoiding affecting the code phase refinement degree at the same time.

According to a preferred embodiment of the invention, the said controller is used to control the input of different lengths of data for each fine acquisition, which comprises steps as follows:
A. The first fine acquisition: According to the coarse acquisition code phase value, Index_{CA} (0 < Index_{CA} < M) obtained by coarse acquisition, the fine acquisition begins to read Nʹ points of data from the position pos1 (pos1 = ceil(^{N}/_{M}) × Index_{CA} — ceil(N/n), where: ceil(^{.}) is a function of rounding up to an integer and M ≤ N′ < N - pos1). The maximum correlation value in the first fine acquisition corresponds to the position of the code phase Index’_{CA} obtained from the first fine acquisition;
B. The second fine acquisition: According to the code phase value, Indexʹ_{CA} (0 < Indexʹ_{CA} < M), the second fine acquisition begins to read N″-point data from the position pos2 ( M ≤ N″ < Nʹ; pos2 = pos1+ ceil (^{Nʹ}/_{M})× Indexʹ_{CA} - ceil(^{N}/ₙ));
Repeat the above until N″⁻ʹ= M, namely refining to the highest accuracy.

According to a preferred embodiment of the invention, the said controller controls the M-point uniform down-sampling for different lengths of data in each fine acquisition process, which comprises steps as follows: The controller calculates the down-sampling multiples according to the number of points of the input data:
C. The first fine acquisition uses a down-sampling multiple of ^{N′}/_{M}= m′, and conducts M-point uniform down-sampling according to the value of m′;
D. The second fine acquisition uses a down-sampling multiple of ^{N″}/_{M} = m″, and conducts M-point uniform down-sampling according to the value of m″;
Repeat the above until N″^{...}ʹ= M, namely refining to the highest accuracy.

According to a preferred embodiment of the invention, the said controller is used to control the generation of different lengths of local pseudo-random codes in each fine acquisition, which comprises steps as follows: the controller controls the local pseudo-random code generator to generate a pseudo-random code at the sampling frequency of fₛ and then takes a part of the pseudo-random code with the same length as the input data size above for M-point uniform down-sampling.

According to a preferred embodiment of the invention, the M -point fast Fourier transform (FFT) formula is as shown in equation (II):

$$X \left(k\right) = F F T \left(x \left(m\right)\right) = {\sum }_{m = 0}^{M - 1} x \left(m\right) e \frac{- j 2 π k m}{M}$$

Where: k = 0,1,2, ..., M — 1; x(m) is a discrete sequence for which the FFT operation is to be performed; X(k) is the result of the discrete Fourier transform; and j is an imaginary unit.

According to a preferred embodiment of the invention, the M-point inverse fast Fourier transform (IFFT) formula is as shown in equation (III):

$$y \left(m\right) = I F F T \left(Y \left(k\right)\right) = {\sum }_{k = 0}^{M - 1} Y \left(k\right) e \frac{j 2 π k m}{M}$$

Where: m = 0,1,2 ..., M — 1; y(m) is the discrete sequence obtained by the inverse Fourier transform; and j is an imaginary unit.

The beneficial effects of the invention are as follows:
1. The invention proposes a GNSS signal acquisition method based on FPGA step-by-step code phase refinement, which can reduce the number of FFT operation points through down-sampling in the coarse acquisition process. As FFT operation points are proportional to the computation load, the acquisition time, and the required hardware resources, a reduced number of FFT points will greatly reduce the computation load of acquisition, save acquisition time, and reduce hardware resources.
2. The invention proposes a GNSS signal acquisition method based on FPGA step-by-step code phase refinement, which takes a part of the data and a part of the pseudo-random code for correlation operation in the fine acquisition process to reduce the computation load, and thus can improve the code phase accuracy compared to the coarse acquisition.
3. The invention proposes a GNSS signal acquisition method based on FPGA step-by-step code phase refinement, which can reuse the coarse acquisition operation module in the fine acquisition process without adding new hardware resource consumption.

### BRIEF DESCRIPTION OF THE FIGURES

FIG. 1 is the functional block diagram of the GNSS signal acquisition method based on FPGA step-by-step code phase refinement in the invention.

FIG. 2 is the overall flow diagram of the GNSS signal acquisition method based on FPGA step-by-step code phase refinement in the invention.

### DETAILED EMBODIMENTS

The invention is further described in combination with the attached figures and embodiments as follows, but is not limited to that.

### Embodiment

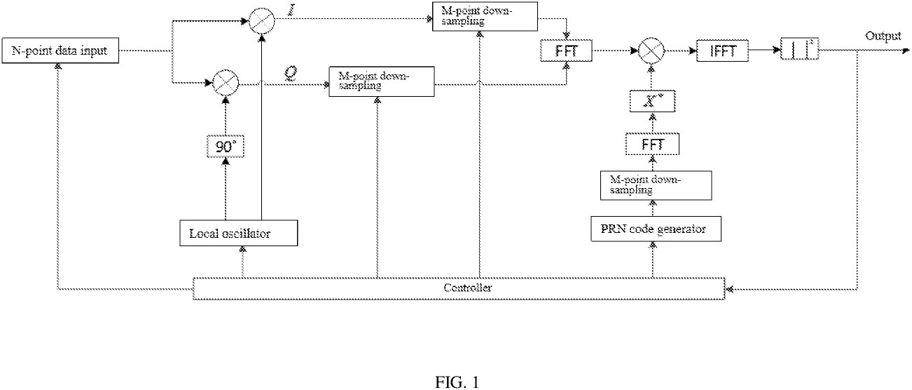

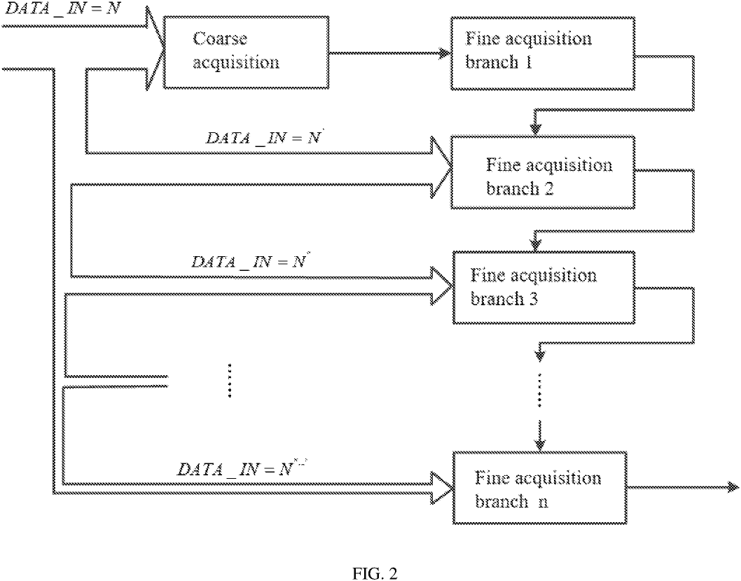

A GNSS signal acquisition method based on FPGA step-by-step code phase refinement (as shown in FIG. 2), which runs in an acquisition system (as shown in FIG. 1) comprising a local oscillator, a down-sampling module, a Fourier transform module, a local pseudo-random code generator, an inverse Fourier transform module, and a controller. The local oscillator is used to generate orthogonal local sine and cosine carrier signals; the down-sampling module is used to down sample long signals with high sampling rate into short signals averagely; the Fourier transform module and inverse Fourier transform module are used to realize the corresponding mathematical operations; the local pseudo-random code generator is used to generate local pseudo-random codes for different satellites; and the controller is used to control the data acquisition, the down-sampling rate, and the acquisition of a part of the local pseudo-random code according to the results of the last acquisition. After the input signal is multiplied by the two orthogonal carrier signals generated by the local oscillator for mixing, the down-sampling module conducts down sampling for the two output signals respectively. After down sampling, the two output signals will be used as real part and imaginary part input signals for the Fourier transform module respectively to obtain intermediate signal I through Fourier transform. At the same time, the local pseudo-random code generator generates a local pseudo-random code which will be input into the Fourier transform module after down sampling in the down-sampling module. Then, intermediate signal II is obtained after taking the conjugate of the signal output by the Fourier transform module. The intermediate signal I is then input into the inverse Fourier transform module for Fourier inverse transform after being multiplied by the intermediate signal II. After modulus operation and square operation, a correlation value will be output for acquisition judgment. The judgment result is then input into the controller for control of the next acquisition. The embodiment takes the application of digital intermediate frequency signal processing in the GPS receiver as an example, which comprises steps are as follows:
A. coarse acquisition:
1) Take a 16368-point GNSS signal r(n) (sampling frequency:fₛ = 16.3676 MHz), and multiply it by the sine and cosine carrier signals sin(2πf_{carry}) and cos (2πf_{carry}) generated by the local oscillator for frequency mixing respectively to get two data, respectively I and Q. f_{I} is the center frequency of the digital signal being processed; f_{carry} = F_{I}- |f_{Doppler}| + Δ • i, where f_{Doppler} is the frequency offset caused by the Doppler effect and is generally±10KHz; Δ is the step size for carrier frequency search, which is user-defined and generally500 Hz; and
$$i = 0 , 1 , 2 , ... , 2 \times \frac{{f}_{D o p p l e r}}{Δ} ;$$
2) Conduct 1024-point uniform down-sampling for the two data I and Q obtained from Step (1) , and use the results as real part and imaginary part respectively for 1024-point fast Fourier transform (FFT);
3) Conduct 1024-point uniform down-sampling for the locally generated pseudo-random code (C/A Code) with length of 16368 and sampling frequency of fₛ = 16.3676 MHz, and take the conjugate of the result after performing 1024-point Fourier transform operation;
4) Multiply the fast Fourier transform (FFT) result from Step (2) and the conjugate result of the pseudo-random code (C/A code) from Step (3) to get Y(k), and then conduct 1024-point inverse fast Fourier transform (IFFT);
5) Perform modulus and square operations on the result from Step (4) to get the sequence of correlation values of the GNSS signal with the local carrier and the local pseudo-random code. Then find the maximum value Max and the secondary maximum Second_{Max} in the correlation value sequence. If Max ≥ 3 × Second_Max, the coarse acquisition can be judged as completed. Then, the frequency of the local carrier is just the carrier value of the coarse acquisition f_{I}, and the position of the maximum value Max in the correlation value sequence is just the coarse acquisition code phase value Index_{CA}(0 < Index_{CA} < 1024). If so, continue with Step (6). Otherwise, return to Step (1); increase the i in Step (1) by 1; change the frequency of the orthogonal carrier signal generated by the local oscillator for the next frequency search.
The coarse acquisition process can reduce the number of FFT operation points through down-sampling. As FFT operation points are proportional to the computation load, the acquisition time, and the required hardware resources, a reduced number of FFT points will greatly reduce the computation load of acquisition, save acquisition time, and reduce hardware resources. Where the input signal sampling frequency fₛ = 16.3676 MHz and the signal length is 1 ms, FFT operations have to be done for a total of 16,368 points if without down-sampling treatment; while if down-sampled to 1024 points, FFT operations only need to be done for 1024 points, which can reduce the number of operation points by 15 times.
B. fine acquisition:
6) Feedback the carrier value f and the coarse acquisition code phase value Index_{CA} obtained from the coarse acquisition in Step (5) to the controller; the controller controls the input of data by reading an 8192 — point part of the GNSS signal data from the chip position pos1(pos1 = 16 × Index_{CA} — 16) in front of the coarse acquisition code phase value obtained from the coarse acquisition and multiply it by the carrier value obtained from the coarse acquisition for orthogonal mixing to eliminate the influence of the carrier and get the two data I1 and Q1.
7) Conduct 1024-point uniform down-sampling for the two data I1 and Q1 obtained from Step (6) under the control of the controller, and use the results as real part and imaginary part respectively for 1024-point fast Fourier transform (FFT);
8) After controlling the local pseudo-random code generator to sample at the frequency of fₛ= 16.3676 MHz, the controller takes an 8192-point (the same long as that in Step (6)) part of the pseudo-random code (C/A code) for 1024-point uniform down-sampling and fast Fourier transform (FFT) operation, and then takes the conjugate of the result;
9) Multiply the data after fast Fourier transform (FFT) from Step (7) by the conjugated data after fast Fourier transform (FFT) from Step (8) for inverse fast Fourier transform (IFFT) operation;
10) Perform modulus and square operations on the result from Step (9) to get the correlation values of the GNSS signal with the local carrier and the local pseudo-random code. Then find the position corresponding to the maximum correlation value. If the position differs from that of the last acquisition by less than one chip, the fine acquisition can be judged as effective. Then, the position corresponding to the maximum correlation value is just the code phase obtained by the fine acquisition. The data length acquired at this time is 8192, which is still larger than 1024. Therefore, the obtained code phase value still has an error caused by down-sampling, and needs to be further refined.
11) Conduct the second fine acquisition. Feedback the code phase Index’_{CA}obtained from the first acquisition in Step (10) to the controller, so that the controller can control the input of data by reading a 4096 — point part of the signal data from the chip position pos2 (pos2 = pos1 + 8 × lndex′_{CA} — 16) in front of the code phase obtained from the coarse acquisition and multiply it by the carrier value obtained from the coarse acquisition for orthogonal mixing to eliminate the influence of the carriers and get the two data I and Q.
12) Conduct 1024-point uniform down-sampling for the two data I and Q obtained from Step (11) under the control of the controller, and use the results as real part and imaginary part respectively for 1024-point fast Fourier transform (FFT);
13) After controlling the local pseudo-random code generator to sample at the frequency of fₛ = 16.3676 MHz, the controller takes a 4096-point (the same long as that in Step (11)) part of the pseudo-random code (C/A code) for 1024-point uniform down-sampling and fast Fourier transform (FFT) operation, and then takes the conjugate of the result;
14) Multiply the data after FFT from Step (12) by the conjugated data after FFT from Step (13) for IFFT operation;
15) Perform modulus and square operations on the result from Step (14) to get the correlation values of the received data with the local carriers and the local pseudo-random code (C/A code). Then find the position corresponding to the maximum correlation value that meets the threshold requirement. As a code phase with a higher accuracy (Indexʺ_{CA}(0 < Indexʺ_{CA} < 1024)), the data length acquired at this time is 4096, which is still larger than 1024. Therefore, the obtained code phase value still has an error caused by down-sampling, and needs to be further refined.
16) Conduct the third fine acquisition. Feedback the code phase Indexʺ_{CA} obtained from the second acquisition in Step (15) to the controller, so that the controller can control the input of data by reading a 2048 — point part of the signal data from the chip position pos3 (pos3 = pos2 + 4 × Indexʺ_{CA} — 16) in front of the code phase obtained from the coarse acquisition and multiply it by the carrier value obtained from the coarse acquisition for orthogonal mixing to eliminate the influence of the carrier and get the two data I and Q.
17) Conduct 1024-point uniform down-sampling for the two data I and Q obtained from Step (16) under the control of the controller, and use the results as real part and imaginary part respectively for 1024-point fast Fourier transform (FFT);
18) After controlling the local pseudo-random code generator to sample at the frequency of f= 16.3676 MHz, the controller takes a 2048-point (the same long as that in Step (16)) part of the pseudo-random code (C/A code) for 1024-point uniform down-sampling and fast Fourier transform (FFT) operation, and then takes the conjugate of the result;
19) Multiply the data after FFT from Step (17) by the conjugated data after FFT from Step (18) for IFFT operation;
20) Perform modulus and square operations on the result from Step (19) to get the correlation values of the received data with the local carrier and the local pseudo-random code (C/A code). Then find the position corresponding to the maximum correlation value that meets the threshold requirement. As a code phase with a higher accuracy
$$\left(I n d e {x}_{C A}^{‴} \left(0 < I n d e {x}_{C A}^{‴} < 1024\right)\right) ,$$
the data length acquired at this time is 2048, which is still larger than 1024. Therefore, the obtained code phase value still has an error caused by down-sampling, and needs to be further refined.
21) Conduct the forth fine acquisition. Feedback the code phase
$$I n d e {x}_{C A}^{‴}$$
obtained from the third acquisition in Step (20) to the controller, so that the controller can control the input of data by reading a 1024 — point part of the data from the chip position pos4 (pos4 = pos3 + 2 ×
$$I n d e {x}_{C A}^{‴}$$
— 16) in front of the code phase obtained from the coarse acquisition and multiply it by the carrier value obtained from the coarse acquisition for orthogonal mixing to eliminate the influence of the carrier and get the two data I and Q.
22) After controlling the local pseudo-random code generator to sample at the frequency of fₛ = 16.3676 MHz, the controller takes a 1024-point (the same long as that in Step (21)) part of the pseudo-random code (C/A code) for fast Fourier transform (FFT) operation, and then takes the conjugate of the result;
23) Multiply the data after FFT from Step (21) by the conjugated data after FFT from Step (22) for IFFT operation;
24) Perform modulus and square operations on the result from Step (23) to get the correlation values of the received data with the local carrier and the local pseudo-random code (C/A code). Then find the position corresponding to the maximum correlation value that meets the threshold requirement. As a code phase with a higher accuracy
$$\left(I n d e {x}_{C A}^{″ ″} \left(0 < I n d e {x}_{C A}^{″ ″} < 1024\right)\right) ,$$
the data length acquired at this time is 1024, which is equal to the number of points for down-sampling. Therefore, the obtained code phase value has no error caused by down-sampling, and the fine acquisition is completed. The final result of the obtained code phase ispos5 = pos4 +
$$I n d e {x}_{C A}^{″ ″}$$

The fine acquisition process of the invention takes a part of the data and a part of the pseudo-random code for correlation operation, and thus can reduce the computational load and improve the code phase accuracy compared to the coarse acquisition. Similarly, when the sampling frequency of the input signal is fₛ = 16.3676 MHz and the signal length is 1 ms, the coarse acquisition process needs to down sample a complete data that contains 16368 points to 1024 points, and the code phase resolution is 16 × ¹/_{fs}. If the first fine acquisition takes 8196 points of the data, and down sample them to 1024 points, the code phase resolution will be 8 × ¹/_{fs}’ which improves the code phase accuracy by one time compared to that of the coarse acquisition. With the help of the second, third and other subsequent fine acquisitions, the code phase accuracy will increase with the decrease of the sampling number and the down-sampling multiple until the maximum code phase accuracy is reached, that is, the code phase resolution equals to ¹/_{fs}.

In this embodiment, the process of uniformly down sampling the 16,368 points in Steps (2) and (3) to 1024 points is as follows:

$$\left\{\begin{matrix}15 < \left(\frac{16368}{1024} \approx 15.98\right) < \text{} 16 \\ 15 x + 16 y = 16368 \\ x + y = 1024\end{matrix}\right)$$

Solution:

$$\left\{\begin{matrix}x = 16 \\ y = 1008\end{matrix}\right)$$

Namely, summation of 15 consecutive points needs to be performed for16 times, while summation of 16 consecutive points needs to be performed 1008 times. In order to uniformly down sample the data, the 16 positions of summation of 15 consecutive points shall be uniformly distributed in the whole data segment. The specific positions are shown in Table 1:

TABLE 1

| ith summation of 15 consecutive points | Position of the summation of 15 consecutive points | ith summation of 15 consecutive points | Position of the summation of 15 consecutive points |
|---|---|---|---|
| 1 | 1008 | 9 | 9192 |
| 2 | 2031 | 10 | 10215 |
| 3 | 3054 | 11 | 11238 |
| 4 | 4077 | 12 | 12261 |
| 5 | 5100 | 13 | 13284 |
| 6 | 6123 | 14 | 14307 |
| 7 | 7146 | 15 | 15330 |
| 8 | 8169 | 16 | 16353 |

In this embodiment, 1024-point down-sampling is performed for the 8192 points of data in Steps (7) and (8) as follows: as

$$\frac{8192}{1024} = 8$$

(8 is an integer), the sum of 8 consecutive data points can be directly taken as a data point after sampling.

Similarly, in this embodiment, 1024-point down-sampling is performed for the 4096 points of data in Steps (12) and (13) as follows: as

$$\frac{4096}{1024} = 4 ,$$

the sum of 4 consecutive data points can be directly taken as a data point after sampling.

Similarly, in this embodiment, 1024-point down-sampling is performed for the 2048 points of data in Steps (17) and (18) as follows: as

$$\frac{2048}{1024} = 2 ,$$

the sum of 2 consecutive data points can be directly taken as a data point after sampling.

What is claimed is:

1. A GNSS signal acquisition method based on FPGA step-by-step code phase refinement, which runs in an acquisition system comprising a local oscillator, a down-sampling module, a Fourier transform module, a local pseudo-random code generator, an inverse Fourier transform module, and a controller, and comprises the steps as follows:
A. coarse acquisition:
(1) take a N-point GNSS signal r(n) (sampling frequency: fₛ), and multiply it by the sine and cosine carrier signals sin(2πf_{carry}) and cos (2πf_{carry} generated by the local oscillator for frequency mixing respectively to get two data, respectively I and Q. The said N-point GNSS signal is a signal that contains a complete pseudo-random code period, while the said complete pseudo-random code period shall contain n chips. fₛ ≥ 2f_{I}, where: f_{I} is the center frequency of the digital signal being processed; f_{carry} = f_{I} - |f_{Dappler} | + Δ · i, where f_{Dappler} is the frequency offset caused by the Doppler effect; Δ is the step size for carrier frequency search, which is user-defined; and
$$i = 0 , 1 , 2 , … , 2 {\times }^{{f}_{D o p p l e r}} / {Δ}^{;}$$
(2) conduct M-point uniform down-sampling for the two data I and Q obtained from Step (1) , and use the results as real part and imaginary part respectively for M-point fast Fourier transform (FFT); M is an integer power of 2 and M < N;
(3) conduct M-point uniform down-sampling for the locally generated pseudo-random code (sampling frequency of fₛ), and take the conjugate of the result after fast Fourier transform (FFT) operation;
(4) multiply the fast Fourier transform (FFT) result from Step (2) by the conjugate result of the pseudo-random code from Step (3) to get Y(k), and then conduct M-point inverse fast Fourier transform (IFFT);
(5) perform modulus and square operations on the result from Step (4) to get the sequence of correlation values of the GNSS signal with the local carrier and the local pseudo-random code. Then find the maximum value Max and the secondary maximum Second_{Max} in the correlation value sequence. If Max ≥ 3 × Second_Max, the coarse acquisition can be judged as completed. Then, the frequency of the local carrier is just the carrier value of the coarse acquisition, and the position of the maximum value Max in the correlation value sequence is just the coarse acquisition code phase value. If so, continue with Step (6). Otherwise, return to Step (1); increase the i in Step (1) by 1, change the frequency of the orthogonal carrier signals generated by the local oscillator for the next frequency search.
B. fine acquisition:
(6) feedback the carrier value and the coarse acquisition code phase value obtained from the coarse acquisition in Step (5) to the controller; the controller controls the input of data by reading a Nʹ-point (M ≤ Nʹ < N) part of the GNSS signal data from the chip in front of the coarse acquisition code phase value obtained from the coarse acquisition and multiply it by the carrier value obtained from the coarse acquisition for orthogonal mixing to eliminate the influence of the carrier and get the two data I1 and Q1;
(7) conduct M-point uniform down-sampling for the two data I1 and Q1 obtained from Step (6) under the control of the controller, and use the results as real part and imaginary part respectively for M-point fast Fourier transform (FFT);
(8) after controlling the local pseudo-random code generator to sample at the frequency of fₛ, the controller takes a Nʹ-point part of the pseudo-random code (the same long as that in Step (6)) for M-point uniform down-sampling and fast Fourier transform (FFT) operation, and then takes the conjugate;
(9) multiply the data after fast Fourier transform (FFT) from Step (7) by the conjugated data after fast Fourier transform (FFT) from Step (8) for inverse fast Fourier transform (IFFT) operation;
(10) perform modulus and square operations on the result from Step (9) to get the correlation values of the GNSS signal with the local carrier and the local pseudo-random code. Then find the position corresponding to the maximum correlation value. If the position differs from that of the last acquisition by less than one chip, the fine acquisition can be judged as effective. Then, the position corresponding to the maximum correlation value is just the code phase obtained by the fine acquisition. The fine acquisition ends when Nʹ = M is met. Otherwise, return to Step (6), and take the chip in front of the code phase of the fine acquisition as starting position of the next fine acquisition to continue with fine acquisition by reducing the data length.

2. The GNSS signal acquisition method based on FPGA step-by-step code phase refinement as described in claim 1, which is characterized in that the said M-point uniform down-sampling comprises the steps as follows:
$$\frac{N}{M} = m ,$$
where: m refers to the number of original data points contained in each down-sampled data point, also known as down-sampling multiple;
when m is an integer, add up every m data as a data point;
when m is not an integer, the following relational expressions are satisfied, as shown in equation (I):
$$\left\{\begin{matrix}a < m < b \\ a x + b y = N \\ x + y = M\end{matrix}\right)$$
where: a and b are integers that are closest to the m respectively; x is the number of summation times for every a consecutive points; and y is the number of summation times for every b consecutive points. a-point summation and b-point summation are to be distributed evenly across the data to complete uniform down-sampling.

3. The GNSS signal acquisition method based on FPGA step-by-step code phase refinement as described in claim 1, which is characterized in that the said controller is used to control the input of different lengths of data for each fine acquisition, which comprises steps as follows:
A. the first fine acquisition: According to the coarse acquisition code phase value, Index_{CA} (0 < Index_{CA} < M) obtained by the coarse acquisition, the fine acquisition begins to read N′ points of data from the position pos1
$$\left(p o s 1 = c e i l \left(\frac{N}{M}\right) \times I n d e {x}_{C A} - c e i l \left(N / n\right)\right)$$
, where: ceil(·) is a function of rounding up to an integer and M ≤ Nʹ < N - pos1). The maximum correlation value in the first fine acquisition corresponds to the position of the code phase
$$I n d e {{x}^{′}}_{C A}$$
obtained from the first fine acquisition;
B. the second fine acquisition: According to the code phase value,
$$I n d e x {’}_{C A} \left(\text{0 <} {\text{Index’}}_{C A} < M\right)$$
, the second fine acquisition begins to read Nʺ points of data from the position pos2
$$\left(M \leq N ” < N ’ ; p o s 2 = p o s 1 + c e l l \left(N ’ / M\right) \times I n d e x {’}_{C A} - c e i l \left(N / n\right)\right) ;$$
Repeat the above until Nʺ···ʹ = M, namely refining to the highest accuracy.

4. The GNSS signal acquisition method based on FPGA step-by-step code phase refinement as described in claim 1, which is characterized in that the said controller controls the M-point uniform down-sampling for different lengths of data in each fine acquisition process, which comprises steps as follows:
C. the first fine acquisition uses a down-sampling multiple of
$$N ’ / M = m ’$$
, and conducts M-point uniform down-sampling according to the value of mʹ;
D. the second fine acquisition uses a down-sampling multiple of
$$N ” / M = m ”$$
, and conducts M-point uniform down-sampling according to the value of mʺ;
repeat the above until
$$N ’ ’ ⋯ ’ = M ,$$
namely refining to the highest accuracy.

5. The GNSS signal acquisition method based on FPGA step-by-step code phase refinement as described in claim 1, which is characterized in that the said controller is used to control the generation of different lengths of local pseudo-random codes in each fine acquisition, which comprises steps as follows: the controller controls the local pseudo-random code generator to generate a pseudo-random code at the sampling frequency of fₛ and then takes a part of the pseudo-random code with the same length as the input data size above for M-point uniform down-sampling.

6. The GNSS signal acquisition method based on FPGA step-by-step code phase refinement as described in claim 1, which is characterized in that the M-point fast Fourier transform (FFT) formula is as shown in equation (II):
$$X \left(k\right) = F F T \left(x \left(m\right)\right) = {\sum }_{m = 0}^{M - 1} x \left(m\right) {e}^{\frac{- j 2 π k m}{M}} \left(\text{II}\right)$$
where: k = 0,1,2,..., M - 1; x(m) is a discrete sequence for which the FFT operation is to be performed; X(k) is the result of the discrete Fourier transform; and j is an imaginary unit.

7. The GNSS signal acquisition method based on FPGA step-by-step code phase refinement as described in claim 1, which is characterized in that the M-point inverse fast Fourier transform (IFFT) formula is as shown in equation (III):
$$y \left(m\right) = I F F T \left(Y \left(k\right)\right) = {\sum }_{k = 0}^{M - 1} Y \left(k\right) {e}^{\frac{j 2 π k m}{M}} \left(\text{III}\right)$$
where: m = 0,1,2 ... , M - 1; y(m) is the discrete sequence obtained by the inverse Fourier transform; and j is an imaginary unit.
